(19) United States
(12) Patent Application Publication
(10) Pub. No.: US 2010/0277839 A1
(43) Pub. Date: Nov. 4, 2010

(54) OVERPOWER PROTECTION CIRCUIT

(75) Inventors: Dean B. NICHOLSON, Windsor, CA (US); Jeffrey P. CAUFFIELD, Windsor, CA (US); Ronald C. BLANC, Santa Rosa, CA (US)

Correspondence Address: Agilent Technologies, Inc. in care of:;CPA Global, P. O. Box 52050, Minneapolis, MN, 55402, US

(73) Assignee: AGILENT TECHNOLOGIES, INC., Loveland, CO (US)

(21) Appl. No.: 12/432,158

(22) Filed: Apr. 29, 2009

(51) Int. Cl. H02H 9/00

(52) U.S. Cl. 361/54

(57) ABSTRACT

A power protection apparatus includes a PIN diode circuit and a solid state limiter. The PIN diode circuit is connected to a signal path for transporting RF signals between a first RF device and a second RF device, the PIN diode circuit including first and second PIN diodes having opposite polarities. The solid state limiter is configured to detect an overpower condition of an RF signal input from the second RF device on the signal path, and to trigger the PIN diode circuit in response to the detected overpower condition, limiting the overpower condition.

### BACKGROUND

Signal sources and radio frequency (RF)/microwave test instrumentation (hereinafter “RF test devices”), such as signal generators, signal analyzers and network analyzers, are exposed to RF signals having excessively high power input from equipment (hereinafter “device under test” or “DUT”) to which the RF test devices connect during the signal generating/testing processes. For example, a signal generator may be exposed to reverse overpower conditions of RF signals input through an output port to which the DUT is connected, while signal and network analyzers may be exposed to forward overpower conditions of RF signals (being analyzed) input through an input port to which the DUT is connected. The RF test devices therefore include overpower protection circuits to prevent damage from reverse and forward high power RF signals.

Typically, conventional overpower protection circuits in RF test devices include mechanically switched relays, which open circuit when an overpower condition of an input RF signal is detected. However, mechanical relays are relatively slow to open circuit. For example, reed relays generally take approximately 20 μs and solenoid-based relays take approximately 400 μs to respond. Accordingly, conventional power protection circuits may incorporate an additional diode-based power protection circuit to provide protection during the delay interval of the mechanical relays and to trigger the mechanical relays. However, such mechanically switched power protection devices are physically large and degrade return loss and insertion loss of the RF test device.

Further, conventional mechanical relays that are relatively compact and inexpensive are limited in their frequency of operation. For example, a conventional solenoid-based relay, available from Radiall USA, Inc., provides power protection from RF signals up to only about 10 GHz. Also, because the mechanical relays physically open circuit a connection, arcing occurs under high power conditions (e.g., over 20 watts), which causes pitting of the mechanical relay contacts. Therefore, the mechanical relays are useful for only about ten open circuit events (to prevent overpower conditions) before RF performance degrades to an unacceptable level due to the contact pitting.

There are also conventional reverse power protection integrated circuit (IC) devices, based on gallium arsenide (GaAs), diodes that respond quickly to RF overpower conditions, as well as electrostatic discharge (ESD). However, GaAs substrates have generally poor thermal conductivity (e.g., 40 W/m-K) and inductive transmission line segments have narrow line widths to compensate out shunt capacitance of the limiting diodes to ground. Therefore, high power RF signals of more than a few watts cause the narrow transmission line segments to overheat, vaporize and permanently open circuit, resulting in failure of the RF test device. Additionally, GaAs diode ICs that use diode stacks to place diodes in series and to reduce shunt capacitance for better high frequency performance have a higher voltage drop across these diodes when conducting current to limit the RF signal. This results in higher thermal dissipation on the IC, which may also lead to failure.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a circuit diagram illustrating a power protection circuit, according to a representative embodiment.

FIG. 2 is a graph illustrating I-V characteristics of a solid state limiter, according to a representative embodiment.

FIG. 3 is a graph illustrating forward current versus series resistance characteristics of a PIN diode, according to a representative embodiment.

FIG. 4 is a circuit diagram illustrating a power protection circuit, according to a representative embodiment.

FIG. 5 is a circuit diagram illustrating a power protection circuit, according to a representative embodiment.

FIG. 6 is a circuit diagram illustrating a power protection circuit, according to a representative embodiment.

FIG. 7 is a circuit diagram illustrating a power protection circuit, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings.

According to various embodiments, an RF test device or other electronic device that receives forward or reverse high power RF signals, includes a power protection circuit that prevents damage and/or failure of the RF test device due to excessively high power from an RF signal injected into a device port connected to the DUT (or other RF signal source). The power protection circuit is useful, for example, in RF test devices that include DC blocking capacitors used to avoid DC signals. According to various embodiments, the power protection circuit is relatively small and inexpensive, has greater than DC to 20 GHz bandwidth, and provides greater than 50 watts of power protection. For example, PIN diodes with lower junction capacitance are used, allowing the overpower limiting with good RF performance to greater than 20 GHz.

PIN diodes are well suited for overpower protection devices due to their ability to handle high RF powers in limiting mode, while having low distortion when reverse biased with proper voltages when handling signals up to 1 watt or greater. PIN diodes have low junction capacitance for power handling capability, which allows PIN diodes to be used for overpower protection of high RF powers to high frequencies. However, PIN diodes have not been used effectively as limiting devices for test instruments and other applications because, in order to limit power levels to amplitudes that do not cause damage to the test instruments, the PIN diodes have require relatively low reverse biases, causing unacceptable amounts of distortion to signal levels near the high power end of the test instruments' specified operating ranges. However, by combining PIN diodes with a low distortion, lower power handling capability triggering mechanism, as described with respect to various embodiments herein, PIN diodes are able to protect test instruments and other devices from high overpower levels to 50 watts and more, up to very high frequencies of 20 GHz and more.

Generally, the power protection circuit includes a pair of opposite polarity diodes, e.g., PIN and NIP diodes, connected in parallel circuits to short circuit high power RF signals to ground when triggered to operate in a forward biased condition. In an embodiment, the forward biasing of the diode pair is triggered in response to sensing current drawn by fast acting diodes, e.g., PN junction or Schottky diodes, of a diode-based limiter connected to the RF signal path. Accordingly, the power protection circuit provides solid state overpower protection for the RF test device, or other RF circuitry, at overpower conditions of up to 50 watts for RF signals having frequencies up to 20 GHz, for example. Also, because the power protection circuit is solid state, it is not limited in the number of times or the length of time it provides overpower protection at very high powers, as compared to mechanical relays, which can only open circuit approximately 10 times at 50 watts before their contacts become pitted and unusable. When in the normal mode of operation for low power RF signals, this power protection apparatus is configured to allow RF signals to pass through it with low loss and low distortion.

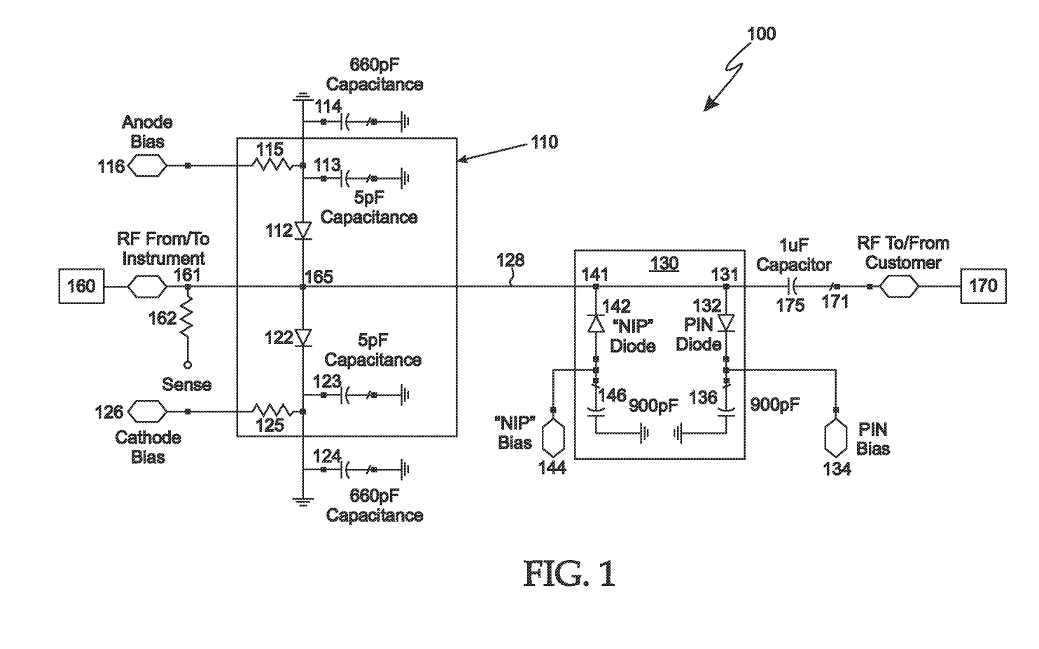

FIG. 1 is a block diagram showing a power protection circuit for an RF test device, according to a representative embodiment.

Referring to FIG. 1, power protection circuit 100 is connected between RF test device 160 at port 161 and DUT 170 at port 171, in order to protect the RF test device 160 from excessive power of RF signals input from the DUT 170 during the RF signal generation or RF test process. The power protection circuit 100 is configured to provide both forward and reverse overpower protection with respect to RF signals received from the DUT 170 through the port 171. For example, when the RF test device 160 is a signal generator that provides RF signals to the DUT 170, the power protection circuit 100 operates to provide reverse overpower protection from RF signals that may sometimes be input through the (output) port 171. Also, when the RF test device 160 is signal or network analyzer that receives and processes RF signals from the DUT 170, the power protection circuit 100 operates to provide forward overpower protection from the RF signals input through the (input) port 171.

Further, for purposes of explanation, the power protection circuit 100 is depicted separately from the RF test device 160. However, it is understood that in various embodiments, the power protection circuit 100 may be a separate unit or may be integrated with the RF test device 160 and/or the DUT 170.

As discussed above, the power protection circuit 100 is a solid state device, and includes solid state limiter 110 and diode circuit 130 connected to RF signal path 128 between input/output ports 161 and 171. The limiter 110 may be an IC limiter, discrete packaged surface mount technology (SMT) or a combination thereof, for example. In an embodiment, the limiter 110 provides power protection for the RF test device 160 at low power levels, such as power levels less than about 2 watts, for example. In addition, the limiter 110 is configured to trigger operation of the diode circuit 130 at higher power levels, such as power levels greater than about 2 watts, for example, by forward biasing diodes 132 and 142 of the diode circuit 130. The limiter 110 detects an overpower condition of an RF signal from the DUT 170 when the limiter 110 draws a predetermined threshold current, such as 30 mA, for example. When triggered by the limiter 110, the diode circuit 130 short circuits the RF signal path 128 to ground, thus reflecting the RF signal input at port 171 to the DUT 170, as discussed below.

In an embodiment, the limiter 110 utilizes fast acting GaAs diodes, such as PN junction or Schottky diodes, for example, indicated by representative diodes 112 and 122 connected to the RF signal path 128 at node 165, and is well impedance matched to 50 ohms. The diodes 112 and 122 may contribute low distortion to the RF signals at amplitudes up to 1 watt, for example, due to the ability to tailor the doping profile of the GaAs used to make the diodes 112 and 122, such that the variation injunction capacitance with variation in reverse voltage bias is minimized. The distortion contributed by the GaAs limiter 110 to the RF signal can be made negligible, compared to the contribution of output amplifiers for signal sources up to power levels of 1 watt and greater, using the tailored doping technique. It is understood that each of the diodes 112 and 122 may represent multiple like diodes connected in series as diode stacks, the number and sizes of which may vary to provide unique benefits for any particular situation or to meet application specific design requirements of various implementations, as would be apparent to one skilled in the art.

In the depicted embodiment, the limiter 110 also includes capacitors 113 and 114, connected between the anode of diode 112 and ground voltage, and capacitors 123 and 124, connected between the cathode of diode 122 and ground voltage. Also, anode bias 116 is connected to the anode of diode 112 and cathode bias 126 is connected to the cathode of diode 122. The limiter 110 is thus configured to quickly detect high power RF signals from the DUT 170. Also, in an embodiment, the limiter 110 is able to limit high power RF signals for a short time period (e.g., a few micro-seconds), temporarily providing overpower protection for a sufficient time to enable activation of the diode circuit 130, discussed below.

In a representative embodiment, the limiter 110 may be configured as a power diverter described by Nicholson et al. in U.S. Pat. No. 6,884,950, the contents of which is hereby incorporated by reference. For example, in a representative embodiment, each of the diodes 112 and 122 may represent a diode stack of multiple (e.g., five) identical GaAs Schottky diodes connected in series between the RF signal path 128 and the anode bias 116 and the cathode bias 126, respectively. Each of the capacitors 113 and 123 has a value of 5 pF, and each of the capacitors 114 and 124 has a value of 660 pF.

Also, a resistor 162 (e.g., 10 kΩ) may be connected between the RF signal path 128 at the port 161 and a sense voltage source in order to monitor DC voltage, maintaining DC voltage at about 0V. When the DC voltage deviates from 0V by a predetermined amount, biases 134 and 144 of PIN/NIP diodes 132 and 42 may be dynamically adjusted accordingly to maintain the approximately 0V. In addition, a resistor 115 (e.g., 1Ω) may be connected between the anode of diode 112 and anode bias voltage 116, and a resistor 125 (e.g., 1Ω) may be connected between the cathode of diode 122 and cathode bias voltage 126. The low value resistors 115 and 125, in series with the anode and cathode bias lines respectively, enable the limiter 110 to sense the current through the diodes (or diode stacks) 112 and 122 to identify an overpower condition.

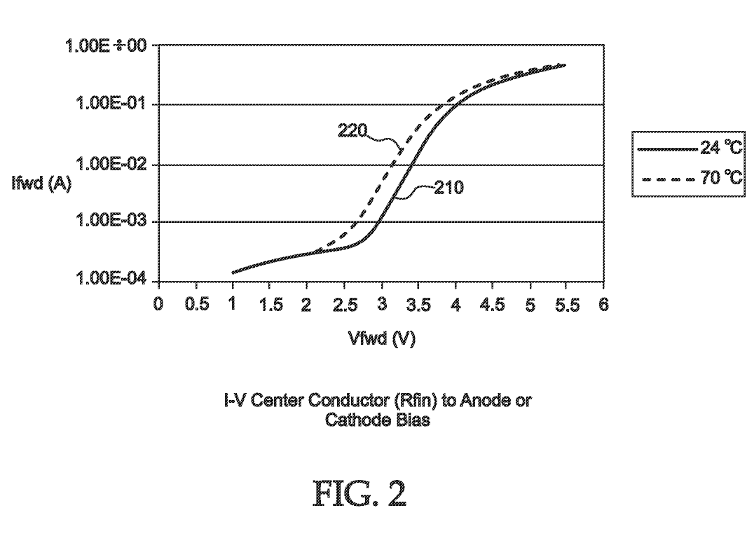

FIG. 2 is a graph showing I-V characteristics of the RF signal path 128 at the port 161 to anode bias 116 or cathode bias 126 for the limiter 110, according to a representative embodiment. In particular, curve 210 shows operation of the limiter 110 at 24° C. and curve 220 shows operation of the limiter 110 at 70° C., for example. FIG. 2 indicates that when the limiter 110 is forward biased beyond approximately 3.5V, it will conduct a large amount of current and limit the RF power, and that this voltage is relatively constant over temperature.

Referring again to FIG. 1, the diode circuit 130 is connected to the RF signal path 128 between the limiter 110 and the port 171 (connecting the DUT 170). In an embodiment, a signal path capacitor 175 may be connected between the diode circuit 130 and the port 171. The diode circuit 130 includes first and second diodes 132 and 142, having opposite polarities. That is, the first diode 132, located closer to the port 171, has an anode connected to the RF signal path 128 at node 131 and a cathode connected to first diode bias 134 and first capacitor 136, which is connected to ground voltage. The second diode 142 has a cathode connected to the RF signal path 128 at node 141, and an anode connected to second diode bias 144 and a second capacitor 146, which is connected to ground voltage. Accordingly, the first diode bias 134 is connected between the first diode 132 and the first capacitor 136, and the second diode bias 144 is connected between the second diode 142 and the second capacitor 146.

In a representative embodiment, the first and second diodes 132 and 142 are identical PIN diodes, where the first diode 132 is connected normally and the second diode 142 is connected in reverse (upside down) in order to reverse its polarity with respect to the first diode 132. However, the first and second diodes 132 and 142 may be implemented as different PIN and NIP diodes, respectively. Generally, a PIN diode is a solid state circuit device having a p-type semiconductor region as anode, an n-type semiconductor region as cathode, and an intrinsic semiconductor region between the p-type and n-type regions.

Also, in the representative embodiment, the first and second capacitors 136 and 146 each has a capacitance of about 900 pF, the capacitor 175 has a capacitance of about 1 μF, and each of the first and second diodes 132 has a reverse bias capacitance of about 0.18 pF, for example. However, the various capacitances may vary to provide unique benefits for any particular situation or to meet application specific design requirements of various implementations, as would be apparent to one skilled in the art.

The reverse bias 134 and 144 for the first and second diodes 132 and 142 are set high enough to avoid causing distortion of the RF signal, but not so high as to cause voltage induced breakdown of the capacitors or diodes, with a typical reverse bias value being approximately 30V. Even with a 30V reverse bias, the first and second PIN diodes 132 and 142 can still easily be forward biased to 100 mA in less than 1 uS. The limiter 110 has sufficient power handling capability to limit the overpower condition of the RF signal (e.g., up to 50 watts or more) for the length of time (e.g., up to 1 uS) sufficient to enable the first and second PIN diodes 132 and 134 to be triggered and to start limiting the overpower condition themselves. That is, the first and second PIN diodes 132 and 142 are strongly reverse biased, for example to 30V, to provide a low loss through state with low RF distortion when there is no overpower condition.

In a representative embodiment, the first and second diodes 132 and 142 are MA4P404-132 PIN diodes, for example, available from M/A-COM, Inc. A MA4P MA4P404-132 PIN diode has a maximum reverse current of 10 μA at a reverse bias of 250V. Also, the maximum resistance specified at 500 MHz is 0.7Ω at 50 mA² and the maximum capacitance specified at 1 MHz is 0.20 pF at 50V. The I-Region width is 30 μm, the contact diameter is 6.8 mils and the thermal resistance is 20° C./W.

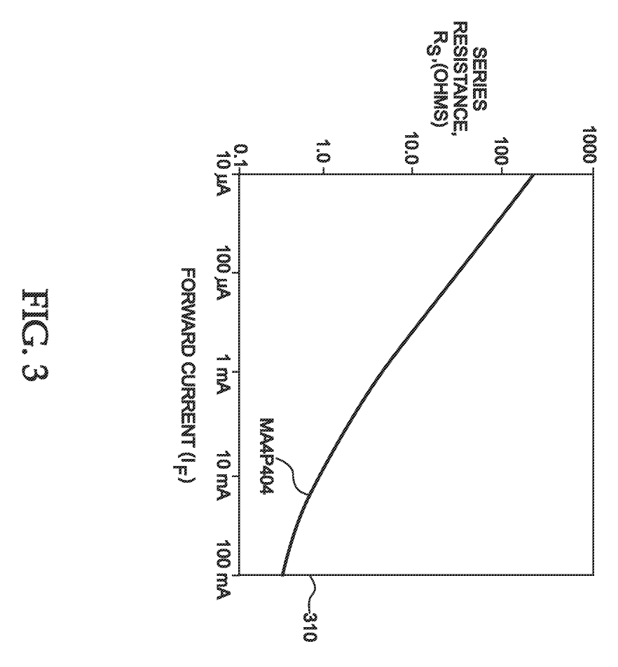

FIG. 3 is a graph showing series resistance as a function of forward current in a MA4P404-132 PIN diode. Thus, as shown by curve 310 in FIG. 3, each of the first and second diodes 132 and 142 in the depicted embodiment has a 0.3Ω series resistance at a 100 mA bias. This low series resistance results in the first and second diodes 132 and 142 effectively shorting the RF signal path 128 to ground, when forward biased.

Accordingly, an overpower condition is initially detected by the limiter 110 when it begins to draw a current in excess of a predetermined threshold current, e.g., 30 mA. In response, the first and second diodes 132 and 142 are forward biased, thus presenting a very low RF series resistance to ground to the RF signal, effectively short circuiting the RF signal. The high power RF signal is reflected back to the port 171.

The first and second diodes 132 and 142 function differently depending on whether the frequency of the RF signal exceeds a particular threshold frequency (e.g., approximately 20 MHz). For example, the first and second diodes 132 and 142 act as PIN diodes for RF signals having a frequency greater than about 20 MHz, and act as ordinary diodes for RF signals having a frequency less than about 20 MHz. Since the PIN diodes 132 and 142 are physically closer together than ¼ wavelength, in the depicted embodiment, they act as though they are in parallel electrically, even though physically one of them is slightly in front of the other. Thus, the combination of the first and second PIN diodes 132 and 142 effectively shorts the RF signal to ground when a frequency of the RF signal exceeds the threshold frequency. When the frequency is below the threshold frequency, the first PIN diode 132 limits the positive going part of the voltage waveform, limiting it to the approximately 0.7V junction voltage of a standard silicon diode in the ON state, and the second PIN diode 142 limits the negative going part of the voltage waveform to the approximately −0.7V from a standard silicon diode in its ON state connected as shown.

Referring again to the representative embodiment of FIG. 1, when the first and second diodes 132 and 142 are acting like PIN diodes and the power protection circuit 100 receives an RF signal having a 50 watt power, for example (originating from 50 ohm impedance), the RMS RF current is 1 amp and thus the short circuit RF current will be 2 amps split evenly between the first PIN diode 132 and the second PIN diode 142. Since each of the first and second diodes 132 and 142 has an RF resistance of ˜0.3 ohms when forward biased, the parallel equivalent resistance will be ˜0.15 ohms, which ideally attenuates the signal by about 44 dB. With most of the 50 W of incoming power reflected by the first and second PIN diodes 132 and 142 back to the DUT 170, power leaking through to the rest of the circuitry of the limiter 110 and the test device 160 will be reduced ideally by the 44 dB, e.g., from its initial value of about 47 dBm down to about 3 dBm, which is within the safe operating range of the circuitry to be protected. However, due to finite leakage of the RF energy across the PIN diodes 132 and 142, for example, due to coupling of input bondwires to output bondwires, the observed attenuation of the signal will be somewhat less than the ideal value of about 44 dB.

The resulting thermal dissipation in each of the first and second diodes 132 and 142 is therefore 0.3 watts (i.e., 0.3Ω×1 amp×1 amp from the formula I²R used to calculate power dissipated) for a total power dissipation of 0.6 watts. When the first and second diodes 132 and 142 are acting as ordinary diodes (i.e., not PIN diodes), e.g., when the RF signal has a frequency below approximately 20 MHz, the first diode 132 reflects the positive going RF pulses of the overpower RF signal by limiting voltage to the silicon diode junction voltage (e.g., 0.7V) and dissipating only 0.7 watts (i.e., 0.7V×1 amp). The second diode 142, e.g., an NIP diode or a PIN diode connected in reverse, limits the negative going RF pulses to the silicon junction voltage, also dissipating only 0.7 watts, for example.

In the example described above, the PIN diodes 132 and 142 clip both positive and negative going peaks of the RF signal to the approximately 0.7V junction voltage of a silicon PIN diode. For an RF signal having a frequency above approximately 20 MHz, the first and second PIN diodes 132 and 142 are close enough to act as a single diode, and so they will both dissipate the same amount of RF power and incur the same thermal rise. For example, as stated above, the RF series resistance to ground of the diodes 132 and 142 will be about 0.3Ω when forward biased at 100 mA. The junction temperature rise versus power dissipation for the first and second diodes 132 and 142 is quite low. For example, for MA4P404-132 PIN diodes, discussed above, the junction temperature rise versus power dissipation is only about 30 deg-C. per watt. Since both the first and second diodes 132 and 142 are mounted on highly thermally conductive substrates, e.g., a silicon capacitor with a thermal conductivity of 156 W/m-K or an aluminum nitride substrate with a thermal conductivity of 180 W/m-K, their temperature rise above the intrinsic thermal resistivity of the PIN diodes is minimized.

In comparison, a lone PIN diode used as a passive RF overpower limiter requires a DC current return path, provided by a diode fast enough to turn on and off at the RF operating frequency, such as a Schottky diode. However, when Schottky diodes are used in limiting applications without reverse bias, they add distortion to the RF signal. Further, the lone PIN diode can only short circuit one polarity of the RF signal and appears as an open circuit to the other polarity of the signal, thus limiting an RF overpower condition by only about 3 dB at low frequencies (e.g., below about 20 MHz). The other polarity of the signal for frequencies below about 20 MHz would turn on the Schottky diode and flow current through it, meaning the Schottky diode would have to also be capable of handling high currents if it is intended to limit high power levels down to very low frequencies.

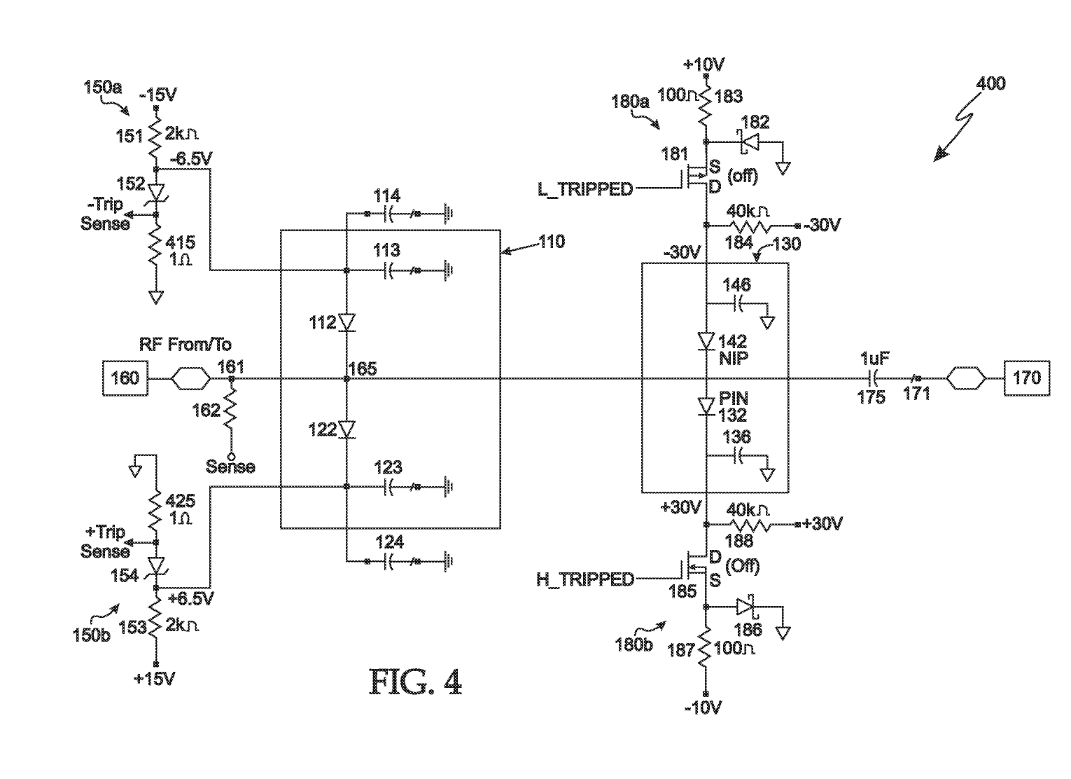

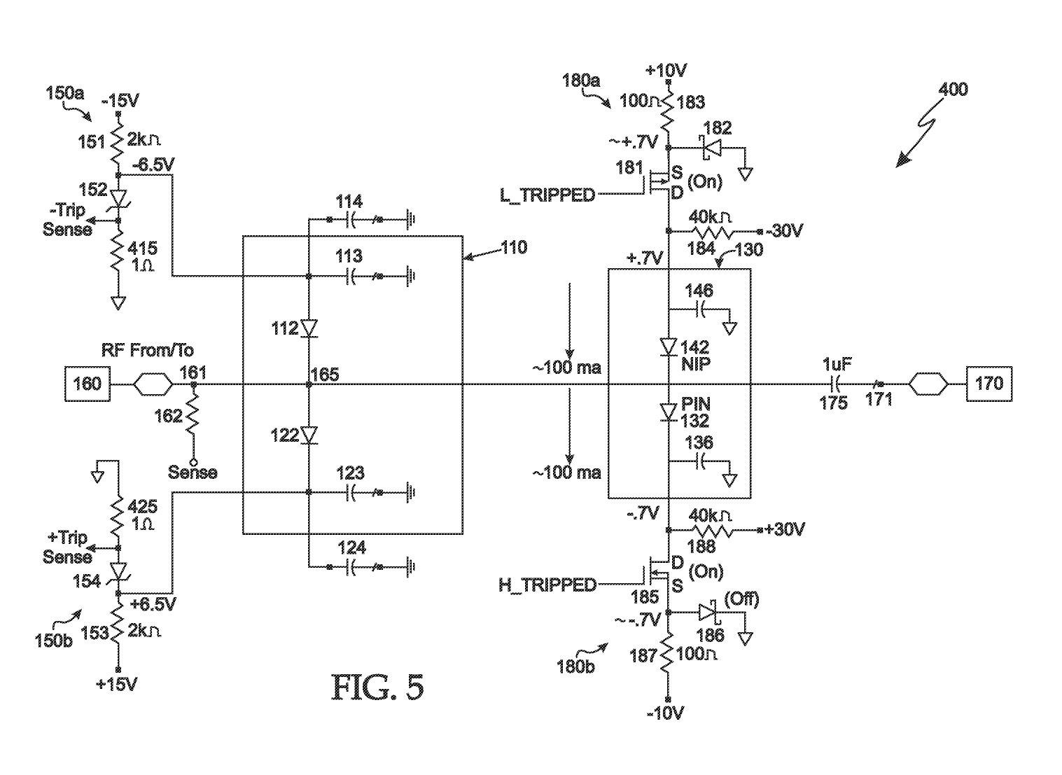

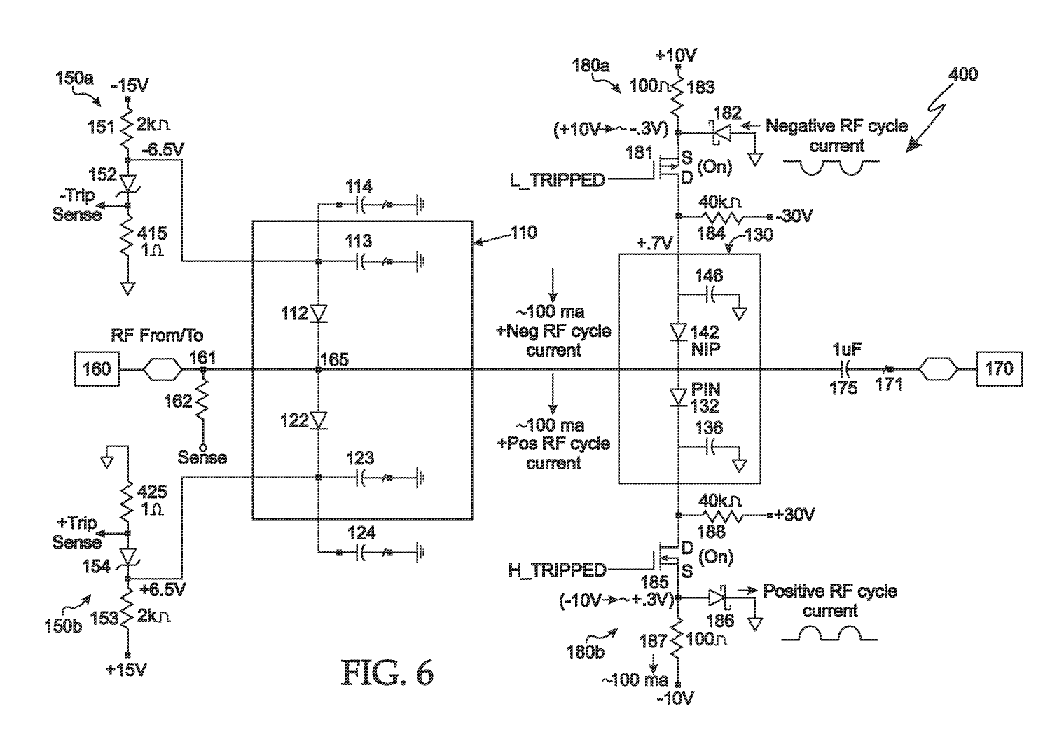

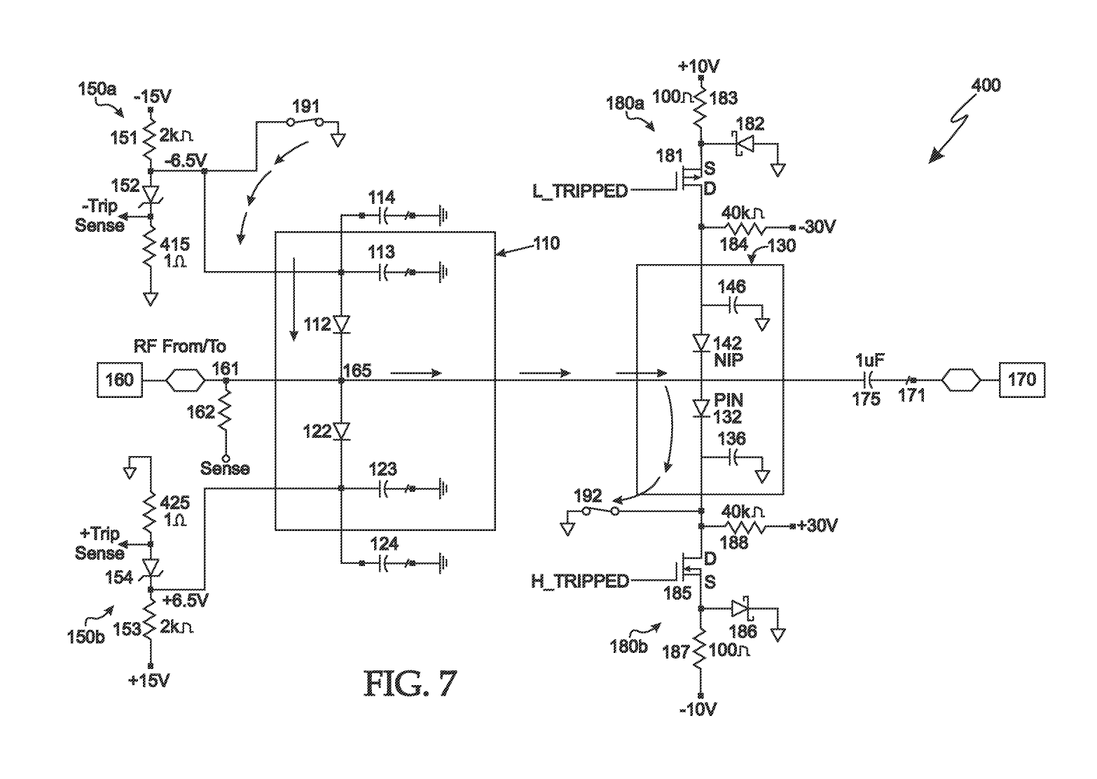

FIGS. 4-7 are circuit diagrams illustrating a power protection circuit, according to representative embodiments, in various stages of operation. More particularly, FIG. 4 shows normal operation, in which the diode circuit 130 has not been triggered by an overpower condition. FIG. 5 shows tripped operation, in which the diode circuit 130 has been triggered in response to an overpower condition, where the RF signal has a frequency above the frequency threshold (e.g., about 20 MHz). FIG. 6 shows tripped operation, in which the diode circuit 130 has been triggered in response to an overpower condition, where the RF signal has a frequency below the frequency threshold (e.g., about 20 MHz). FIG. 7 shows AC power off operation, in which the limiter 110 and the diode circuit 130 provide protection from an overpower condition, where the overpower protection circuit 100 has electrical power removed, but remains connected to the DUT 170.

With respect to FIGS. 4-7, like components have the same reference numbers shown in FIG. 1, such as the limiter 110 and the diode circuit 130, and therefore the description of these components will not be repeated. Further, additional circuitry, such as trip sensing circuits 150a/150b and diode bias circuits 180a/180b, included in each of the FIGS. 4 -7 will be described only with respect to FIG. 4.

FIG. 4 shows an overpower protection circuit 400, which includes limiter 110, diode circuit 130, trip sensing circuit 150a/150b and diode bias circuit 180a/180b.

The trip sensing circuits 150a/150b sense current flow through the representative diodes 112 and 122 of the limiter 110, indicating an overpower condition of the RF signal. More particularly, the trip sensing circuit 150a is connected to the anode of the diode 112 for sensing current flow through the diode 112, and the trip sensing circuit 150b is connected to the cathode of the diode 122 for sensing current flow through the diode 122. The trip sensing circuit 150a includes diode 152, which may be a Zener diode, for example, having an anode connected to the anode of the diode 112. The anode of the diode 152 is also connected to a negative voltage source through resistor 151 and a cathode of the diode 152 is connected to ground through trip sense resistor 415. The trip sensing circuit 150b includes diode 154, which may also be a Zener diode, for example, having a cathode connected to the cathode of the diode 122. The cathode of the diode 154 is also connected to a positive voltage source through resistor 153 and an anode of the diode 154 is connected to ground through trip sense resistor 425.

In the depicted embodiment, the voltage sources are −15V/+15V and the diodes 152 and 154 effectively act as voltage regulators. Also, the resistors 151 and 153 each have a resistance of about 2 kΩ, and the trip sense resistors 415 and 425 each have a resistance of about 1Ω, although these values may vary to provide unique benefits for any particular situation or to meet application specific design requirements of various implementations, as would be apparent to one skilled in the art.

The trip sensing circuits 150a and 150b provide negative and positive trip sensing based on detected voltage across the trip sense resistors 415 and 425, respectively, indicating current flow through the diodes 112 and 122. When such current flow is detected, a tripped state is latched in flipflops (not shown), for example, respectively corresponding to the trip sensing circuits 150a and 150b, discussed below with respect to FIGS. 5 and 6. In FIG. 4, however, the condition is shown in which no current is sensed through the diodes 112 and 122, so the limiter 110 acts normally and the diode circuit 130 is not triggered.

The diode biasing circuits 180a/180b bias the first and second diodes 132 and 142 of the diode circuit 130, in response to being triggered by the trip sensing circuits 150a/150b, based on an overpower condition of the RF signal. More particularly, the diode biasing circuit 180a is connected to the anode of the second diode 142 for biasing the second diode 142, and the diode biasing 180b is connected to the cathode of the first diode 132 for biasing the first diode 132.

The diode biasing circuit 180a includes trip transistor 181, which may be a p-channel metal-oxide semiconductor field-effect transistor (MOSFET), for example, having a drain connected to the anode of the second diode 142, a source connected to a positive voltage source through resistor 183, and a gate connected to a low tripping signal L_TRIPPED (from the trip sensing circuit 150a) that selectively turns the trip transistor 181 ON and OFF. The diode biasing circuit 180a also includes diode 182, which may be a silicon Schottky diode, for example, having an anode connected to ground and a cathode connected to the source of the trip transistor 181. The diode biasing circuit 180a also includes a high resistance resistor connected between the anode of the second diode 142 and a negative high voltage source. The diode biasing circuit 180b includes trip transistor 185, which may be an n-channel MOSFET, for example, having a drain connected to the cathode of the first diode 132, a source connected to a negative voltage source through resistor 187, and a gate connected to a high tripping signal H_TRIPPED (from the trip sensing circuit 150b) that selectively turns the trip transistor 185 ON and OFF. The diode biasing circuit 180b also includes diode 186, which may be a silicon Schottky diode, for example, having a cathode connected to ground and an anode connected to the source of the trip transistor 185. The diode biasing circuit 180b also includes a high resistance resistor connected between the cathode of the first diode 132 and a positive high voltage source.

In the depicted embodiment, the voltage sources are +10V/−10V and the high voltage sources are −30V/+30V, respectively. Also, the resistors 183 and 187 each have a resistance of about 100Ω, and the high resistance resistors 184 and 188 each have a resistance of about 40 kΩ. However, these values may vary to provide unique benefits for any particular situation or to meet application specific design requirements of various implementations, as would be apparent to one skilled in the art.

As stated above, FIG. 4 depicts normal or “untriggered” operation, in which no overpower condition of the RF signal in RF signal path 128 has been detected. Accordingly, the trip transistors 181 and 185 remain OFF, in response to respective levels of the low and high tripping signals L_TRIPPED and H_TRIPPED. The first and second diodes 132 and 142 are therefore reversed biased, e.g., by +30V and −30V, respectively, enabling the RF signal to flow through the diode circuit 130 with no distortion.

FIG. 5 depicts an overpower condition or “triggered” operation, in which an overpower condition of an RF signal from the DUT 170 has been detected, where the RF signal has a frequency greater than the threshold frequency (e.g., about 20 MHz).

Referring to FIG. 5, the trip sensing circuits 150a and 150b sense current flow through the representative diodes 112 and 122 in the limiter 110, by detecting voltage across the trip sense resistors 415 and 425, respectively, indicating the overpower condition. For example, in the depicted embodiment, the detected voltage across the trip sense resistors 415 and 425 is about 30 mV. In response, a tripped state voltage is latched in a flip-flops (not shown). The latched voltage may be applied to gates of trip transistors 181 and 185, as the low and high tripping signals L_TRIPPED and H_TRIPPED, respectively, turning on the trip transistors 181 and 185, and thus trigging limiting operations of the diode circuit 130.

Because the RF signal in the RF signal path 128 has a frequency greater than the threshold frequency, the Schottky diodes 182 and 186 remain OFF. This results in a voltage of about +0.7V forward biasing the second diode 142 and a voltage of about −0.7V forward biasing the first diode 132, and a current of about 100 mA passing through the first and second diodes 132 and 142. The combination of the first and second diodes 132 and 142 therefore provides negligible RF resistance, effectively shorting the RF signal to ground and reflecting the overpowered RF signal back to the DUT 170.

In an embodiment, the low and high tripping signals L_TRIPPED and H_TRIPPED continue to be applied to the trip transistors 181 and 185, and the diode circuit 130 thus remains in the triggered state, until the flip-flops are reset. The flip-flops may be reset manually, e.g., by a user activating a button or switch on a control panel or software interface of the overpower protection circuit 400, or automatically, e.g., after a predetermined period of time or upon detection of the overpower condition ending.

FIG. 6 depicts an overpower condition or “triggered” operation, in which an overpower condition of an RF signal from the DUT 170 has been detected, where the RF signal has a frequency less than (or equal to) the threshold frequency (e.g., about 20 MHz).

Referring to FIG. 6, the trip sensing circuits 150a and 150b sense current flow through the representative diodes 112 and 122 in the limiter 110, by detecting voltage across the trip sense resistors 415 and 425, respectively, indicating the overpower condition. For example, in the depicted embodiment, the detected voltage across the trip sense resistors 415 and 425 is about 30 mV. In response, a tripped state voltage is latched in flip-flops (not shown). The latched voltage may be applied to gates of trip transistors 181 and 185, as the low and high tripping signals L_TRIPPED and H_TRIPPED, respectively, turning on the trip transistors 181 and 185, and thus trigging operation of the diode circuit 130.

Because the RF signal in the RF signal path 128 has a frequency less than the threshold frequency, the first and second diodes 132 and 142 act as regular silicon diodes, as discussed above, and the Schottky diodes 182 and 186 turn ON. This results in each of the diode biasing circuits 180a and 180b providing one half of a rectified sine wave via the Schottky diodes 182 and 186, respectively. For example, the current through the second PIN diode 142 is about 100 mA plus the negative RF cycle current from the Schottky diode 182, and the current through the first PIN diode 132 is about 100 mA plus the positive RF cycle current from the Schottky diode 186. Accordingly, the first and second PIN diodes 132 and 142 become forward biased, and are thus connected in series to ground through the Schottky diodes 186 and 182, respectively. The diode circuit 130 effectively becomes a ±1V rectifier, and the combination of the first and second diodes 132 and 142 provides negligible resistance, effectively shorting the RF signal to ground and reflecting the overpowered RF signal back to the DUT 170.

FIG. 7 is a circuit diagram illustrating a power protection circuit, according to representative embodiments. In FIG. 7, the AC power has been turned off to or otherwise removed from the power protection circuit 400, although the power protection circuit 400 remains connected to the DUT 170, exposing the power protection circuit 400 and/or the test device 160 to potential damage from over power conditions.

In the depicted embodiment, the power protection circuit 400 further includes first switch 191, connected to the anode of the representative diode 112 of the limiter 110, and second switch 192, connected to the cathode of the first diode 132 of the diode circuit 130. The first and second switches 191 and 192 may be small, low frequency mechanical relays, for example. The first and second switches 191 and 192 have a normal closed condition when no power is applied to the power protection circuit 400, and an open condition when power is applied to the power protection circuit 400.

In operation, when AC power is removed from the power protection circuit 400, which remains connected to the DUT 170 via the RF signal path 128, the first and second switches 191 and 192 close. Therefore, the power protection circuit 400 operates using only representative diode 112 in the limiter 110 and the first diode 132 in the diode circuit 130, shown by the series of arrows indicating a path from the first switch 191 to the second switch 192. When the representative diode 112 is a fast acting Schottky diode (or stack of fast acting Schottky diodes) and the first diode 132 is a PIN diode, as discussed above, the power protection circuit 400 effectively functions as a Schottky assisted PIN diode limiter.

Accordingly, for RF signals having a frequency above about 20 MHz, the first and second switches 191 and 192 provide a way for the first diode 132 to be biased by an overpower RF signal even with the AC power turned off. Also, for RF signals having a frequency below about 20 MHz, the first and second switches 191 and 192 provide approximately 3dB of limiting by causing the first diode 132 to clip a positive going portion of the waveform for overpower RF signals to a 0.7V maximum.

In addition, diode 112 (e.g., a Schottky diode) will limit negative going portions of waveforms at frequencies above the threshold frequency (e.g., 20 MHz) until the first diode 132 (e.g., PIN diode) is turned on by the DC bias, and thus provide the primary limiting. In this manner, the overpower protection circuit 400 provides greater than 50 watts of overpower protection when the overpower protection circuit 400 and/or the RF test device 160 has main AC power turned off or disconnected completely from AC or DC power sources.

Also, the first diode 132 will limit positive going portions of waveforms below the threshold frequency (e.g., 20 MHz). For high powers (e.g., above approximately 2 watts), there will be so much current conducted through diode 112 that the SMT diode or trace on the integrated circuit may be damaged or destroyed, so the limiter 110 by itself not effective for limiting high power RF signals for long periods of time when biased in this configuration with the AC power OFF. Hence, for frequencies less than the threshold frequency (e.g., 20 MHz) and with AC power OFF, the overpower protection circuit 400 is only effective to approximately 2 watts of power.

While specific embodiments are disclosed herein, many variations are possible, which remain within the concept and scope of the present teachings. Such variations would become clear after inspection of the specification, drawings and claims herein. The embodiments therefore are not to be restricted except within the scope of the appended claims.

What is claimed is:

1. A power protection apparatus, comprising:
a PIN diode circuit connected to a signal path for transporting RF signals between a first RF device and a second RF device, the PIN diode circuit comprising first and second PIN diodes having opposite polarities; and
a solid state limiter configured to detect an overpower condition of an RF signal input from the second RF device on the signal path and to trigger the PIN diode circuit in response to the detected overpower condition, limiting the overpower condition.

2. The apparatus of claim 1, wherein the solid state limiter has sufficient power handling capability to limit the overpower condition of the RF signal for a length of time sufficient to enable the first and second PIN diodes to be triggered and to start limiting the overpower condition.

3. The apparatus of claim 1, wherein the solid state limiter triggers the PIN diode circuit by forward biasing the first and second PIN diodes.

4. The apparatus of claim 3, wherein both of the first and second PIN diodes present a negligible RF series resistance to ground to the RF signal when forward biased, reflecting the RF signal back to the second RF device.

5. The apparatus of claim 3, wherein the first PIN diode comprises an anode connected to the signal path and the second PIN diode comprises a cathode connected to the signal path.

6. The apparatus of claim 5, wherein a combination of the first and second PIN diodes effectively shorts the RF signal to ground when a frequency of the RF signal exceeds a threshold frequency, and
wherein the combination of the first and second PIN diodes, acting as regular silicon diodes in conjunction with biasing Schottky or PN junction diodes, effectively shorts the RF signal to ground when the frequency of the RF signal does not exceed the threshold frequency.

7. The apparatus of claim 6, wherein the threshold frequency is approximately 20 MHz.

8. The apparatus of claim 1, wherein the second PIN diode is the same type diode as the first PIN diode, connected in reverse.

9. The apparatus of claim 1, wherein the solid state limiter comprises at least one third diode connected between a solid state limiter anode bias and the signal path, and at least one fourth diode connected between a solid state limiter cathode bias and the signal path.

10. The apparatus of claim 9, wherein the at least one third diode and the at least one fourth diode of the solid state limiter comprise gallium arsenide (GaAs) diodes.

11. The apparatus of claim 1, wherein the first RF device comprises a signal generator and the second RF device comprises a device under test, the RF signal input from the second RF comprising a reverse RF signal.

12. The apparatus of claim 1, wherein the RF test device comprises one of a signal analyzer and a network analyzer, and the second RF device comprises a device under test, the RF signal input from the second RF device comprises a forward RF signal.

13. A power protection apparatus for protecting a radio frequency (RF) test device from an overpower condition, caused by an RF signal input from a device under test (DUT) on a signal path connected to the RF test devise, the power protection apparatus comprising:
a first PIN diode comprising an anode connected to the signal path configured to receive the RF signal from the DUT, and a cathode connected to ground;
a second PIN diode comprising a cathode connected to the signal path between the RF test device and the first PIN diode and an anode connected to ground; and
a solid state limiter connected to the signal path between the RF test device and the second PIN diode, the solid state limiter being configured to detect the overpower condition of the RF signal input from the DUT and to trigger the first and second PIN diodes to short circuit the RF signal.

14. The apparatus of claim 13, wherein the solid state limiter detects the overpower condition based on a magnitude of current drawn by the solid state limiter.

15. The apparatus of claim 14, wherein the magnitude of current drawn by the solid state limiter that detects the overpower condition is about 30 mA.

16. The apparatus of claim 13, wherein the solid state limiter triggers the first and second PIN diodes by forward biasing the first and second PIN diodes

17. The apparatus of claim 16, wherein a combination of the first and second PIN diodes short circuits the RF signal when a frequency of the RF signal exceeds a threshold frequency, and the combination of the first and second PIN diodes, acting as regular silicon diodes in conjunction with biasing Schottky diodes or PN junction diodes, short circuits the RF signal when the frequency of the RF signal does not exceed the threshold frequency.

18. The apparatus of claim 13, wherein a power of the RF signal is between 10 watts and 50 watts.

19. A power protection apparatus for protecting a radio frequency (RF) test device from an overpower condition of an RF signal from a device under test (DUT), the power protection apparatus comprising:
a first PIN diode comprising an anode connected to a signal path at a first node for receiving the RF signal from the DUT, and a cathode connected to a first PIN diode bias, the signal path connecting the RF test device and the DUT;
a second PIN diode comprising a cathode connected to the signal path at a second node between the RF test device and the first node, and an anode connected to a second PIN diode bias;
a first fast acting gallium arsenide (GaAs) diode comprising a cathode connected to the signal path at a third node between the RF test device and the second node, and an anode connected to a first GaAs diode bias; and
a second fast acting GaAs diode comprising an anode connected to the signal path at the third node, and a cathode connected to a second GaAs diode bias,
wherein the first and second PIN diodes are forward biased by the first and second PIN diode biases, respectively, in response to threshold current drawn by the first and second GaAs diodes indicating an overpower condition of the RF signal, in order to short circuit the RF signal.

20. The apparatus of claim 19, wherein the first and second PIN diodes are strongly reverse biased in order to provide a low loss through state with low RF distortion when there is no overpower condition.
